(19) United States
(12) Patent Application Publication
(10) Pub. No.: US 2004/0058076 A1
(43) Pub. Date: Mar. 25, 2004

(54) METHOD FOR FABRICATING POLYSILICON LAYER

(76) Inventor: Chia-Tien Peng, Hsinchu Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,874

(22) Filed: Nov. 27, 2002

(30) Foreign Application Priority Data
Sep. 24, 2002 (TW) 91121833

(51) Int. Cl. B05D 5/12; B05D 3/02; B05D 1/36

(52) U.S. Cl. 427/376.2; 427/595; 427/402; 427/58

(57) ABSTRACT

A method for fabricating a polysilicon layer includes (a) providing a substrate; (b) forming a barrier layer on the substrate; (c) forming a porous layer on the barrier layer; (d) forming an amorphous silicon layer on the porous layer; and (e) performing laser annealing process. Additionally, a stress buffer layer can form between the barrier layer and the porous layer. Due to the low thermal conductivity of the porous layer, the polysilicon layer having larger grain size is formed.

### CROSS REFERENCE TO RELATED APPLICATIONS

This application claims the priority benefit of Taiwan application serial no. 911 21833, filed on Sep. 24, 2002.

### BACKGROUND OF INVENTION

1. Field of Invention

The present invention relates to a method for fabricating a polysilicon layer. More particularly, the present invention relates to a method for fabricating a polysilicon layer with a larger grain size using a porous layer with low thermal conductivity.

2. Description of Related Art

The Low Temperature Polysilicon Liquid Crystal Display (LTPS LCD) is different from the conventional amorphous thin film transistor liquid crystal display (a-Si TFT-LCD), wherein its electron mobility can reach above 200 cm²/V-sec. Therefore, the area occupied by the thin film liquid crystal display device can be even smaller to accommodate the high aspect ratio demand in order to increase the brightness of the display and to mitigate the problem of power consumption. Further, increasing the electron mobility can have a portion of the driving circuit and the thin film transistor to form together on a glass substrate to greatly increase the reliability of the liquid crystal display panel and to greatly reduce the manufacturing cost of the panel. Therefore, the Low Temperature Polysilicon Liquid Crystal Display comprises the attributes of being thin, low weight, and high resolution, which are very applicable to the light-weight, energy efficient mobile end products.

The channel layer of the Low Temperature Polysilicon Liquid Crystal Display is usually formed by excimer laser annealing. The property of this channel layer is determined by the grain size and uniformity of polysilicon. The grain size and uniformity of polysilicon is directly related to the energy control of the excimer laser.

FIGS. 1A to 1C are schematic diagrams illustrating the fabrication process for a polysilicon layer according to the prior art. Referring to FIG. 1A, a substrate 100 is provided, wherein the substrate 100 is usually a glass substrate. A buffer layer 102 is then formed on the substrate 100. This buffer layer 102 is typically formed with a barrier layer 102a and stress buffer layer 102b. The barrier layer 102a is, for example, a silicon nitride layer, while the stress buffer layer 102b is, for example, a silicon oxide layer.

Referring to FIGS. 1B and 1C, an amorphous silicon layer 104 is formed on the stress buffer layer 102b subsequent to the formation of the buffer layer 102. An excimer laser annealing process is then performed and energy used to irradiate the amorphous silicon layer is properly controlled 104 to almost completely melt the amorphous silicon layer 104. Only the seed of crystallization is retained on the surface of the buffer layer 102b. Thereafter, the melted liquid silicon would start to crystallize from the seed of crystallization to form an amorphous silicon layer 106. Further, grain boundary is present in the polysilicon layer 106. Based on the distribution of the grain boundary, grain size of the polysilicon layer can be determined.

Conventionally, the stress buffer layer 102b that is in contact with the amorphous silicon layer 104 is usually a chemically vapor deposited silicon oxide layer, wherein its film structure is denser and its thermal conductivity is about 0.014 W/cm-K (20 degrees Celsius). In the conventional excimer laser annealing process, the thermal conductivity of the stress buffer layer directly affects the grain size of the polysilicon layer. If the thermal conductivity of the stress buffer layer is lower, the polysilicon layer can form with a larger grain size. Therefore, during the excimer thermal annealing process, the thermal conductivity of the film layer that is in contact with the amorphous silicon layer, for example, the stress buffer layer, needs to be lower further to grow a polysilicon layer with a larger grain size.

### SUMMARY OF INVENTION

Accordingly, the present invention provides a fabrication method for a polyslilicon layer, wherein the thermal conductivity of the thin film in contact with the amorphous silicon layer is lower to form a polysilicon layer comprising a larger grain size.

In accordance to the present invention, the fabrication method for a polysilicon layer comprises (a) providing a substrate; (b) forming a barrier layer on the substrate; (c) forming a stress buffer layer on the barrier layer; (d) forming a porous material layer with a low thermal conductivity on the stress buffer layer; (e) forming an amorphous silicon layer on the porous material layer; and (f) performing an excimer laser annealing process.

In accordance to the present invention, the fabrication method for a polysilicon layer further comprises (a) providing a substrate; (b) forming a barrier layer on the substrate; (c) forming a porous material layer with a low thermal conductivity on the barrier layer; (d) forming an amorphous silicon layer on the porous material layer; and (e) performing a laser annealing process.

According to one aspect of the present invention, the barrier layer, for example, comprises silicon nitride, and is formed by chemical vapor deposition. The stress buffer layer, for example, comprises silicon oxide, and is formed by chemical vapor deposition.

According to the one aspect of the present invention, the porous material layer is formed by, for example, e-beam evaporation. The porous material is formed with, for example, silicon oxide or a silicon oxide/aluminum oxide alloy, wherein a ratio of silicon oxide to aluminum oxide is about 95:5 ratio. Further, the thermal conductivity constant of the above porous material layer is lower than 0.014 W/cm-K (20 degrees Celsius).

In this aspect of the present invention, the porous material layer is about 500 angstroms to about 2000 angstroms thick. The corresponding barrier layer is about 500 angstroms thick, while the stress barrier layer is about 1500 angstroms thick.

In this aspect of the present invention, the laser annealing process is, for example, an excimer laser annealing process.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A to 1C are schematic, cross-sectional views illustrating the conventional fabrication process for a polysilicon layer;

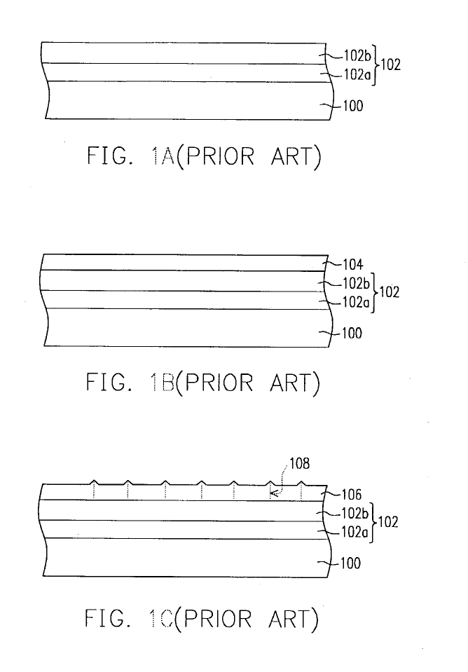

FIGS. 2A to 2C are schematic cross-sectional views illustrating the fabricating process for a polysilicon layer according to a first aspect of the present invention;

FIG. 3 is a diagram illustrating the relationship between laser energy and grain size; and

FIGS. 4A to 4C are schematic, cross-sectional views illustrating the fabricating process for a polysilicon layer according to a second aspect of the present invention.

### DETAILED DESCRIPTION

If the thermal conductivity of the stress buffer layer can be lower further during the laser annealing process, the polysilicon layer can form with a greater grain size. The different aspects of the present invention are directed to an improvement on the film layer of the buffer layer, which is in contact with the amorphous silicon layer. By lowering the thermal conductivity constant of the buffer layer, the polysilicon layer is thus grown with a larger grain size.

First Aspect of the Present Invention

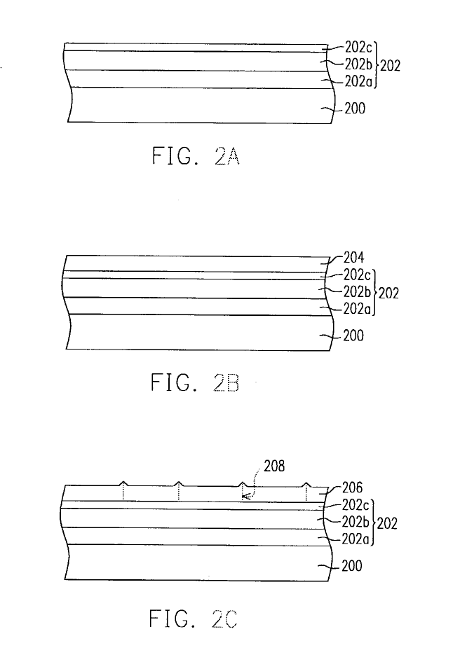

FIGS. 2A to 2C are schematic, cross-sectional views illustrating the fabrication process for a silicon layer according to a first aspect of the present invention. Referring to FIG. 2A, a substrate 200 is provided. The substrate 200 is, for example, a glass material, plastic material or other transparent material. The substrate 200 can also be a non-transparent material, such as, a silicon substrate.

A buffer layer 202 is then formed on the substrate 200. This buffer layer 202 is formed with a barrier layer 202a, a stress buffer layer 202b and a porous material layer 202c, wherein the barrier layer 202a is formed by, for example, chemical vapor deposition. Further, the barrier layer 202a is a denser film, such as, a silicon nitride layer. The stress buffer layer 202b is formed by, for example, chemical vapor deposition. The stress buffer layer is, for example, a silicon oxide layer. The porous material layer 202c is formed by, for example, e-beam evaporation. This porous material layer 202c is, for example, silicon oxide or a silicon oxide/aluminum oxide alloy, wherein the silicon oxide to aluminum oxide ratio is about 95:5.

The porous material layer 202c adopted by the first aspect of the present invention is, for example, silicon oxide or a silicon oxide/aluminum oxide alloy. The thermal conductivity of this material is lower than 0.014 W/cm-K (20 degrees The thermal conductivity of silicon oxide is about 0.014 W/cm-K (20 degrees Celsius). Therefore, if the porous material layer 202c is a silicon oxide material, the thermal conductivity of the porous material layer 202c is lower than 0.014 W/cm-K (20 degrees Celsius) due to presence of pores in the porous material layer 202c. Similarly, the porous material layer 202c formed by a silicon oxide/aluminum oxide alloy can also provide a thermal conductivity constant lower than 0.014 W/cm-K (20 degrees Celsius).

Referring to FIGS. 2B and 2C, after forming the buffer layer 202, an amorphous silicon layer 204 is formed on the surface of the porous material layer 202c of the buffer layer 202. The amorphous silicon layer 204 is formed by, for example, low pressure chemical vapor deposition (LPCVD). Further, subsequent to the formation of the amorphous silicon layer 204, a laser annealing process is performed. The laser annealing process is, for example, an excimer laser thermal annealing. During the laser annealing process, the energy of the excimer laser used to irradiate the amorphous silicon layer is properly controlled to almost completely melt the amorphous silicon layer 204. The melted amorphous silicon layer 204 is then recrystallized to form a polysilicon layer 206. The polysilicon layer 206 formed by laser annealing process would comprise grain boundary 208. The grain size can be determined from the grain boundary 208.

The porous material layer 202c shown in FIGS. 2A to 2C is about 500 angstroms to about 2000 angstroms thick. The barrier layer 202a is about 500 angstroms thick, while the stress buffer layer 202b is about 1500 angstroms thick.

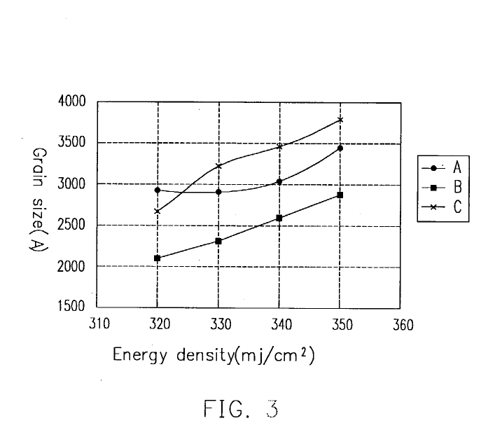

FIG. 3 is a diagram illustrating the relationship between laser energy and grain size. Table 1 summarizes the barrier layer thickness, the stress buffer layer thickness, the porous material layer thickness and the buffer layer total thickness of the buffers layers in FIG. 3. Referring to both Table 1 and FIG. 3 concurrently, as shown in Table 1, the barrier layer in each group of the A, B, C, buffer layers is about 500 angstroms thick, while the stress buffer layer is about 1500 angstroms thick. One point that is worth noting is that the porous material layer in group A of the buffer layer is about 855 angstroms thick, while group B does not include any buffer layer. The porous material layer in group C of the buffer layer is about 1227 angstroms thick.

TABLE 1

| | A | B | C |
|---|---|---|---|
| Barrier Layer Thickness (Å) | 500 | 500 | 500 |
| Stress Buffer Layer Thickness (Å) | 1500 | 1500 | 1500 |
| Porous Material Layer Thickness (Å) | 855 | 0 | 1227 |
| Buffer Layer Total Thickness (Å) | 2855 | 2000 | 3227 |

As shown in FIG. 3, under higher laser energy, a larger grain size is formed. Further, under a same energy level, a larger grain size is formed in group C. The experimental result is compatible with the present invention, in which the presence of a porous layer promotes the formation of a larger grain size, and the thickness of the porous material preferably ranges from 500 angstroms to 2000 angstroms.

Second Aspect of the Present Invention

The second aspect of the present invention is similar to the first aspect. The only difference is that the fabrication of the stress buffer layer is eliminated to provide a further thinning of the device and simplification of the manufacturing process.

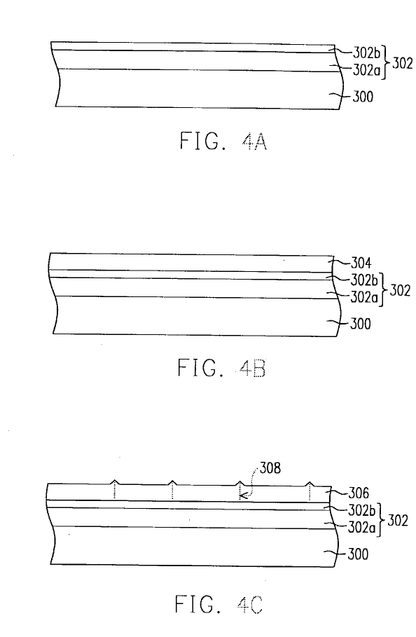

FIGS. 4A to 4C are schematic, cross-sectional views illustrating the fabrication process of a polysilicon layer according the second aspect of the present invention. Referring to FIG. 4A, a substrate 300 is provided. The substrate 300 includes a glass substrate, a plastic substrate or other transparent substrate. The substrate 300, however, also includes other non-transparent substrate, such as, a silicon substrate.

Thereafter, a buffer layer 302 is formed on the substrate 300, wherein this buffer layer 302 comprises a barrier layer 302a and a porous material layer 302b, and wherein the barrier layer 302a is formed by chemical vapor deposition. Further, the barrier layer 302a is, for example, a denser film, such as, a silicon nitride layer. The porous material layer 302b is formed by, for example, e-beam evaporation. The porous material layer 302b comprises, for example, silicon oxide.

The porous material layer 302b adopted by the second aspect of the present invention is, for example, silicon oxide. The thermal conductivity of this material is lower than 0.014 W/cm-K (20 degrees Celsius). The thermal conductivity of silicon oxide is about 0.014 W/cm-K (20 degrees Celsius). Therefore, if the porous material layer 302b is a silicon oxide material, the thermal conductivity of the porous material layer 302b is lower than 0.014 W/cm-K (20 degrees Celsius) due to presence of pores in the porous material layer 302b.

Referring to both FIGS. 4B and 4C, after forming the buffer layer 302, an amorphous silicon layer 204 is formed on the surface of the porous material layer 302b of the buffer layer 302. The amorphous silicon layer 304 is formed by, for example, low pressure chemical vapor deposition (LPCVD). Further, subsequent to the formation of the amorphous silicon layer 304, a laser annealing process is performed. The laser annealing process is, for example, an excimer laser thermal annealing. During the laser annealing process, the energy of the excimer laser used to irradiate the amorphous silicon layer 304 is properly controlled to almost completely melt the amorphous silicon layer 304. The melted amorphous silicon layer 304 is then recrystallized to form a polysilicon layer 306. The polysilicon layer 306 formed by the laser annealing process comprises grain boundary 308. The grain size can be determined from the grain boundary 308.

As shown in FIGS. 4A to 4C, the porous material layer 302b is about 500 to 2000 angstroms thick, while the corresponding barrier layer 302a is about 500 angstroms thick.

In accordance to the fabrication method for a polysilicon layer of the present invention, through the direct contact of the porous material layer with the amorphous silicon layer, the polysilicon layer is grown to comprise greater grain size due to the lower thermal conductivity of the porous material layer.

Additionally, since the commonly practiced e-beam evaporation method is used in the fabrication method of a polysilicon layer of the present invention for the thin film deposition, the fabrication of a porous material layer will not increase the manufacturing cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for fabricating a polysilicon layer, comprising:
providing a substrate;
forming a barrier layer on the substrate;
forming a porous material layer on the barrier layer, wherein the barrier layer
and the porous material layer form a buffer layer;
forming an amorphous silicon layer on the porous material layer; and
performing a laser annealing process to form a polysilicon layer.

2. The method of claim 1, wherein the barrier layer is formed by chemical vapor deposition.

3. The method of claim 1, wherein the barrier layer comprises silicon nitride.

4. The method of claim 1, wherein the porous material is formed by e-beam evaporation.

5. The method of claim 1, wherein the porous material layer comprises silicon oxide.

6. The method of claim 1, wherein the porous material layer comprises an alloy of silicon oxide and aluminum oxide.

7. The method of claim 6, wherein a ratio of the silicon oxide to the aluminum oxide in the silicon oxide/aluminum oxide alloy is about 95:5.

8. The method of claim 1, wherein the thermal conductivity of the porous material layer is lower than 0.014 W/cm-K (20 degrees Celsius).

9. The fabrication method of claim 1, wherein the laser annealing process includes an excimer laser annealing process.

10. A fabrication method of a polysilicon layer, comprising:
providing a substrate;
forming a barrier layer on the substrate;
forming a stress buffer layer on the barrier layer;
forming a porous material layer on the stress buffer layer, wherein a thermal conductivity constant of the porous material layer is lower than that of the stress buffer layer, and the barrier layer, the stress buffer layer and the porous material layer form a buffer layer;
forming an amorphous silicon layer on the porous material layer; and
performing a laser annealing to form a polysilicon layer.

11. The method of claim 10, wherein the barrier layer is formed by chemical vapor deposition.

12. The method of claim 10, wherein the barrier layer comprises silicon nitride.

13. The method of claim 10, wherein the stress buffer layer is formed by chemical vapor deposition.

14. The method of claim 10, wherein the stress buffer layer comprises silicon oxide.

15. The method of claim 10, wherein the porous material is formed by e-beam evaporation.

16. The method of claim 10, wherein the porous material layer comprises silicon oxide.

17. The method of claim 10, wherein the porous material layer comprises an alloy of silicon oxide and aluminum oxide.

18. The method of claim 17, wherein a ratio of the silicon oxide to the aluminum oxide in the silicon oxide/aluminum oxide alloy is about 95:5.

19. The method of claim 10, wherein the thermal conductivity of the porous material layer is lower than 0.014 W/cm-K (20 degrees Celsius).

20. The method of claim 10, wherein the laser annealing process includes an excimer laser annealing process.
